(19) United States
(12) Patent Application Publication
(10) Pub. No.: US 2025/0374978 A1
(43) Pub. Date: Dec. 11, 2025

(54) ILLUMINATED CYCLE HANDWEAR

(71) Applicants: Marc David Weinberg, San Diego, CA (US); Maxwell Paul Weinberg, Philadelphia, PA (US)

(72) Inventors: Marc David Weinberg, San Diego, CA (US); Maxwell Paul Weinberg, Philadelphia, PA (US)

(21) Appl. No.: 19/230,964

(22) Filed: Jun. 6, 2025

Related U.S. Application Data
(60) Provisional application No. 63/656,908, filed on Jun. 6, 2024.

(51) Int. Cl. A41D 19/015

(52) U.S. Cl. CPC A41D 19/0157; A41D 19/01523

(57) ABSTRACT

A cycling glove configured to be worn on a hand of a bike-riding wearer includes one or more lighted components configured to emit light visible from at least a position distal and laterally adjacent to the glove-wearing hand of the wearer. In embodiments, the cycling glove has a plurality of lighted components, each lighted component positioned to align with the dorsal aspect of one of the metacarpophalangeal finger joints of the glove-wearing hand of the wearer, each inset within a rigid knuckle-protective member.

### CROSS-REFERENCE TO RELATED APPLICATIONS

This application claims priority to U.S. Provisional Application Ser. No. 63/656,908, titled ILLUMINATED CYCLE HANDWEAR, filed Jun. 6, 2024, incorporated herein by reference in its entirety.

### BACKGROUND OF THE INVENTION

Motorcycle riders and bicycle riders (“cyclists”) must share the road with automobiles, SUVs, trucks, buses, and other larger motor vehicles that can cause great harm to cyclists in the event of a collision. Because motorcycles and bicycles are typically smaller relative to other motor vehicles, they are also typically less visible to drivers. This combination of lesser visibility and lack of protective structure surrounding the cyclist makes cyclists more vulnerable in a collision with other types of motor vehicles. According to the National Highway Traffic Safety Administration, despite accounting for only 3.5% of registered vehicles, motorcyclists comprised 14% of all motor vehicle traffic fatalities in 2021.

Accordingly, any ways to make cyclists more visible to drivers may have a direct benefit on the overall safety of the cyclists.

### SUMMARY OF THE INVENTION

Aspects of the invention relate to handwear configured to be worn on a donned hand of a wearer, the handwear comprising one or more lighted components configured to emit light visible from at least a position distal and laterally adjacent to the donned hand of the wearer. The one or more lighted components may be positioned on a dorsal side of the handwear, preferably positioned to align with a finger joint of the donned hand of the wearer, more preferably to align with dorsal aspect of a metacarpophalangeal joint of the donned hand of the wearer. The handwear may comprise a glove, wherein each of the lighted components is inset within a rigid knuckle-protective member positioned to align with the dorsal aspect of one of the metacarpophalangeal finger joints of the donned hand of the wearer. In exemplary embodiments, the glove may have a knuckle protection impact transition resistance of less than 9 kN, optionally less than 5 kN., to an impact created by dropping a 2.5-kilogram mass onto each glove with an impact energy of 5 joules.

In embodiments with a plurality of (e.g. four) lighted components, each lighted component may be positioned to align with the dorsal aspect of one of the metacarpophalangeal finger joints of the donned hand of the wearer. In embodiments, at least one of the lighted components is configured to have a different color than at least one of the other of the plurality of lighted components, the lighted components may be configured to blink, flash, or strobe in one or more patterns., or to blink, flash, and/or strobe between a first color light and a second color light or to strobe a static color. Each of the plurality of lighted components may be configured to alternate between a first color light and a second color light, wherein the first color light of each lighted component is different from the first color light of each other lighted component, and the second color light of all of the lighted components is the same, such as wherein the second color light comprises white light, and the first color light is selected from the group consisting of: yellow, green, orange and non-emergency shades of red and blue.

In embodiments, the handwear may include a handwear-mounted controller of the one or more lighted components, the controller configured to establish a communication link with a second controller not mounted on the handwear and to control at least one aspect of the one or more lighted components based upon a signal received from the second controller, such as a second controller comprising application software installed on a mobile device or a second controller configured to control lighted features of a vehicle operated by the wearer. The first controller may be configured to control an aspect of the one or more lighted components selected from the group consisting of: on/off, intensity, blinking/flashing/strobing pattern, color, and combination thereof, based upon a signal received from the second controller. The first controller may be configured to change the aspect of the one or more lighted components based upon a signal from the second controller corresponding to activation of one or more lights on the motorcycle consisting of: a turn signal, a hazard flasher, a brake light, a headlight, a parking light, a running light, or a combination thereof.

Embodiments may include at least one activation switch disposed on the handwear for controlling one or more functions selected from the group consisting of: on/off status, color selection, and illumination pattern. Embodiments may include one item of handwear configured to be donned on a left hand and another item of handwear configured to be donned a right hand of the wearer, the one and the another items of handwear comprising a pair.

A handwear system embodiment may include a pair of handwear and a handwear-mounted controller disposed in each item of handwear, wherein each handwear-mounted controller is configured to be communicatively coupled to a remote controller configured to control an aspect of the one or more lighted components in at least one of the items of handwear based upon a signal received from the remote controller. Systems may include a vehicle-mounted remote controller configured to communicate an illumination signal from the vehicle or a mobile-device-mounted controller comprising interactive application software running on the mobile device configured to send one or more operating signals to the handwear based upon wearer input.

Another aspect of the invention relates to a glove or pair of gloves configured to be worn on at least one donned hand of a wearer, each glove comprising a plurality of lighted components, each lighted component configured to emit light visible from at least a position distal and laterally adjacent to the donned hand of the wearer, each of the lighted components inset within a rigid knuckle-protective member positioned to align with the dorsal aspect of one of the metacarpophalangeal finger joints of the donned hand of the wearer, each glove having a knuckle protection impact transition resistance of less than 9 kN, measured by dropping a 2.5-kilogram mass onto the glove with an impact energy of 5 joules. In embodiments, at least one lighted component is configured to have a different color than at least one other lighted component; one or more lighted components are configured to blink, flash, or strobe in one or more patterns; one or more lighted components are configured to blink, flash, and/or strobe between a first color light and a second color light or to strobe a static color, or a combination thereof. Each glove may comprise a glove-mounted controller configured to control the plurality of lighted components, establish a communication link with a second controller not mounted on the glove, and control at least one aspect of the one or more lighted components based upon a signal received from the second controller. At least one activation switch disposed on at least one glove may control on/off status, color selection, illumination patterns, or a combination thereof.

### BRIEF DESCRIPTION OF THE DRAWINGS

FIG. 1A is a dorsal view illustration depicting an exemplary handwear embodiment as described herein, in an unilluminated configuration.

FIG. 1B is a dorsal view illustration depicting the exemplary handwear embodiment of FIG. 1A, with some lights illuminated.

FIG. 2 is a schematic dorsal view illustration depicting an exemplary item of handwear with activation switches.

FIG. 3A is a schematic dorsal view illustration of an exemplary illuminator structure comprising a light source, enclosure, and shroud.

FIG. 3B is a schematic side view illustration of the exemplary illuminator structure of FIG. 3A.

FIG. 4 is a schematic diagram of exemplary electronics embedded in an exemplary glove.

### DETAILED DESCRIPTION OF THE INVENTION

Embodiments of the invention relate to handwear (e.g. gloves) configured to be worn on a hand of a cyclist, the glove comprising one or more lighted components configured to emit light visible from at least a position distal and laterally adjacent to the glove-wearing hand, which may be referred to herein as the “donned hand,” of the wearer. Although commonly referred to herein as “gloves” or a “glove,” the handwear may take any form, including a form in which portions of the hand (i.e. ends of the wearer's fingers) are exposed. Likewise, although embodiments include gloves intended to be worn by a wearer when riding a vehicle, aspects of the invention are not limited to any particular use.

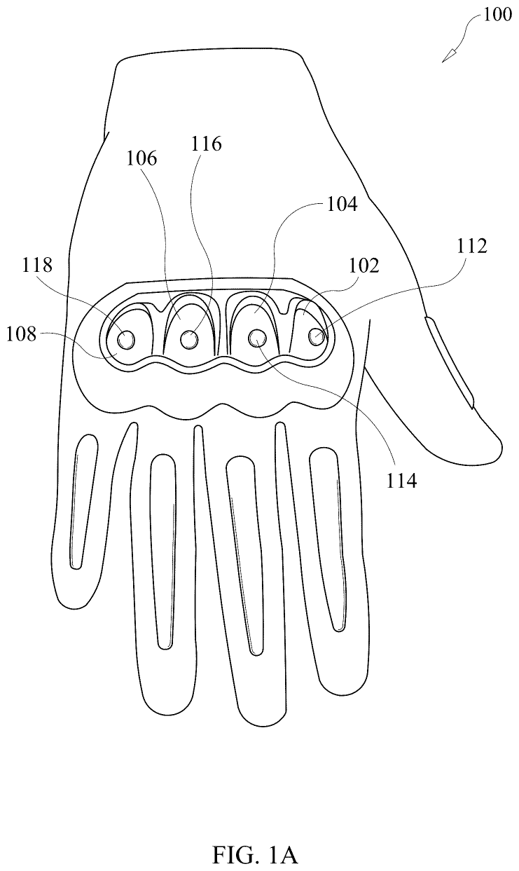

FIGS. 1A and 1B depict a motorcycle glove 100 having hard, plastic knuckle protectors 102, 104, 106, 108 positioned on a dorsal side of the glove aligned with the metacarpophalangeal finger joints (i.e. first knuckles, closest to the wrist) of the wearer. Gloves with knuckle protectors are generally known in the art, and embodiments of the invention are not limited only to the type of gloves shown. As shown in FIGS. 1A and 1B, each knuckle protector has been configured with lighted components 112, 114, 116, 118, referred to herein as illuminators (e.g. light emitting diodes—LEDs) inset below the surface of the knuckle protector. The illuminators in each glove comprise four lighted components, each positioned to align with the dorsal aspect of one of the metacarpophalangeal finger joints of the glove-wearing hand of the rider. As depicted, there is no illuminator on the thumb knuckle, although the invention is not limited to the presence or absence of illuminators on any particular finger or thumb.

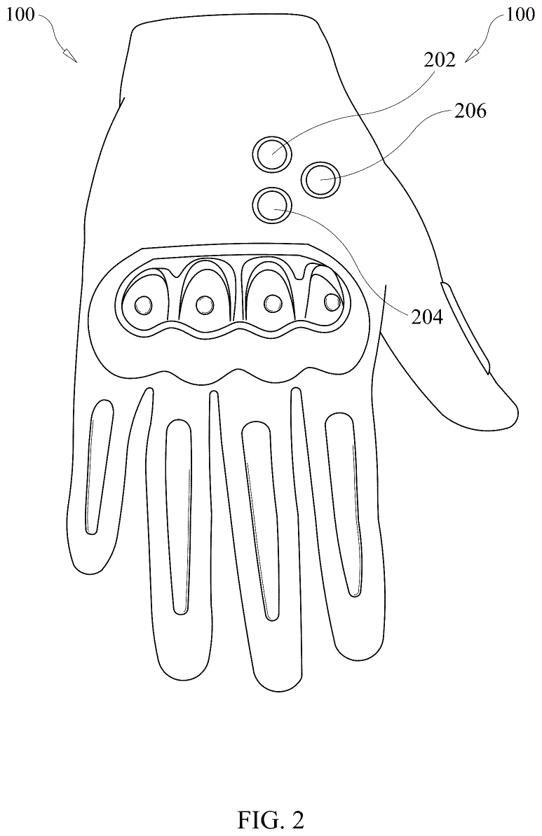

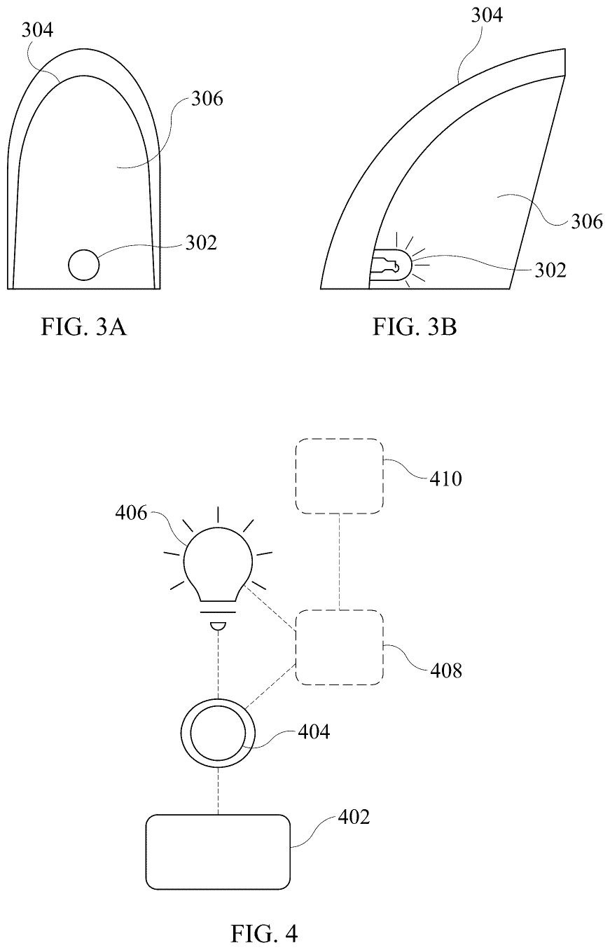

As depicted, the LEDs are disposed in or behind boreholes in the knuckle protectors that permit the light emitted from the LEDs to project from the boreholes. The LEDs are disposed under the knuckle protector, which may help to protect the LEDs from damage in the event of a crash and, in turn, prevent the rider from being injured by pieces of broken LEDs. In other embodiments, depicted schematically in FIGS. 3A and 3B, the illuminators 302 may be disposed in a transparent or translucent enclosure 306 (which may form part of the hard knuckle protector) configured to transmit light in front of (distally relative to the glove) and laterally (e.g. at least 90 degrees from the front to each of the sides) of the glove wearer, with a shroud 304 to block light from the illuminator directly shining in the eyes of the wearer, at least when the glove is positioned with the shroud disposed between the wearer's eye and the illuminator, such as when the wearer has his or her gloved hands on the handlebars of the bike.

Although sometimes referred to herein as LEDs, the illuminators of the gloves as described herein are not limited to LEDs. Likewise, although depicted above in a motorcycle glove embodiment, it should be understood that use of such gloves is not limited to being worn by the rider of any particular type of vehicle. In particular, the gloves are suitable for use for operators of any vehicle in which the wearer's hands are exposed and/or normally disposed on handlebars for controlling the vehicle and/or for use in vehicles that lack protective structure surrounding the rider or otherwise expose the wearer to increased risk of being unseen by fellow drivers relative to drivers of automobiles, trucks, buses, and the like. Accordingly, the terms “cycle” or “bike” as referred to herein, refer to motorized and non-motorized vehicles with any number of wheels, including but not limited to bicycles, motorcycles, scooters, mo-peds, three-wheeled and four-wheeled bikes (e.g. ATVs and UTVs), personal transporters such as made by Segway, skateboards (including motorized single-wheel boards such as made by ONEWHEEL of Santa Cruz, CA) and the like. Likewise, the term “cycling glove” is used to refer to a glove as described herein configured to be worn by a wearer riding any of the foregoing types of vehicles. However, it should be understood that there is no limitation regarding the activities of the wearer of the illuminated gloves. While the gloves are particularly useful to be worn while cycling, the gloves can be worn by a wearer who Is not in or on a vehicle. For example, road construction workers, walkers (e.g. dog walkers), and others who are in the vicinity of a street or highway may also find the gloves to be particularly useful for visibility, especially when adjacent a road at a time when visibility is compromised (by darkness, fog, rain, snow, etc.). Again, however, there is no limit to weather conditions or adjacency to a road for a wearer.

The openings in the knuckle protector may define a passage having a cylindrical or conical geometry, and the sidewalls of the passage may be coated with a reflective finish to maximize light emanated from the passages. A lens (not shown) may be disposed at the surface. Depending upon the heat generated by the LEDs, the knuckle protectors may also be lined with a heat dissipating material to conduct the heat away from the wearer.

FIG. 1A depicts the gloves with the illuminators switched off, and FIG. 1B depicts the gloves with some of the illuminators switched on. In embodiments, at least one of the illuminators may be configured to have a different color than at least one of the other of the plurality of illuminators. For example, each of illuminators 112, 114, 116, and 118 in FIG. 1B may be configured to emit a different color light from each other illuminator, all may be configured to emit the same color, or subsets of the full set of illuminators may be configured to emit the same color as other illuminators in the subset that is different than the color in other subsets. When on, the illumination may comprise white light, colored light, or a combination thereof. The illumination may be static, dynamic (e.g. blinking/flashing/strobing), and/or may transition from one color to another. The illuminators may be configured to blink and/or strobe in one or more patterns, including one or more patterns of blinking or strobing between a first color light to a second color light (and to third, fourth, etc. colors of light) or all blinking or strobing at one time or in any combination. The gloves may be configured to cause the illuminators to emit light in any number of combinations, which may be selected by the wearer. For example, certain LEDs are capable of emitting any one of numerous colors of light. Exemplary gloves may be configured to switch between white light and colored light, between blinking, strobing or static, and may allow the wearer to select among multiple blinking or color patterns, including patterns in which the gloves move through a plurality of different colors and/or patterns in a controlled or random fashion. The blinking pattern and/or color are not limited to any particular color or pattern or combination of colors and patterns; however, as a practical matter, colors may be selected to avoid “emergency” colors (i.e. red or blue) that may cause violations of local or state ordinances that prohibit use of certain colored lights except by emergency response vehicles. Embodiments may be styled in colors corresponding to the colors of sports teams or colors that serve as a source indicator or brand affiliation, and the handwear may have additional corresponding branding.

It should be understood that as used herein, the terms “strobing” or “blinking” or “flashing” refers to a regular (or irregular) pattern of on/off or low intensity/high intensity activation of light that is perceptible to the human eye and intended to catch the attention of someone in the sight line of the light. Alternations in pattern may refer to changes in frequency of light-on time and/or light-off time, intensity at the low or high illumination levels, light color, changes in illumination color sequence or illumination location sequence, changes in light color combinations simultaneously illuminated, or any characteristic of the light from each source and/or the collective combination of light sources. The term “pattern” may refer to a repeating pattern, a regular or irregular pattern, or a random or chaotic pattern, without limitation. In general, although not limited to any strict definition, strobe lights are typically understood to provide higher luminous intensity per flash as compared to flashing or blinking lights and may emit flashes at rates from several times per second up to tens of thousands of flashes per minute.

For example, a strobing light may have a frequency of 1-4 Hz—Hertz (Hz)=frequency per second—meaning that the strobe flashes 1 to 4 times per second. Strobing lights also tend to have more abrupt changes between lowest and highest intensity illumination levels (which may be 0 and 100 percent intensity, respectively, or in any smaller range therein) and may have greater intensity, generally, than blinking or flashing lights that may blink or flash on/off at a lower frequency and may have less harsh, more gradual changes in illumination between the lowest and highest illumination levels. The frequency of the strobing/blinking/flashing may be adjustable by a wearer or may be preset to ensure compliance with local regulations regarding flashing or strobing lights on highways. While LED lights routinely strobe at a very fast frequency not typically perceived by most humans (e.g. 3125 Hz), strobing as referred to herein is intended to refer to eye-catching, human-perceptible strobing. Most humans reportedly have a “critical flicker frequency” (CFF)—at which they perceive a flickering light source as a continuous source—that does not exceed 100 Hz. Thus, effective human-perceptible strobing is typically in a range of less than 50 Hz, although the invention is not limited to any particular strobe frequency.

In an exemplary embodiment, each of the plurality of lighted components is configured to alternate between a first color light and a second color light, wherein the first color light of each lighted component is different from the first color light of each other lighted component, and the second color light of all of the lighted components is the same.

The second color light may include white light, and the first color light may be selected from the group consisting of: yellow, green, orange (e.g the shade of orange used for safety cones and/or construction related items),, and non-emergency shades of red and blue.

Embodiments may feature yellow or orange lights akin to those used for vehicle turn signals or parking lights, and some embodiments may include controllers in communication with a controller of turn signals for the motorcycle. For example, a communications interface for the gloves may be in communication (e.g. via Bluetooth or some other near field communications protocol) with an output of the motorcycle (e.g. as configured normally for controlling a trailer) for controlling the lighted components of the motorcycle (e.g. turn signals, brake lights, headlights, etc.). In other embodiments, the gloves may be configured for communication (e.g. via Bluetooth or some other near field communications protocol) with mobile device application software running on a wearer's phone or other mobile device. Such an application may be configured to permit the wearer to control colors, patterns, and other options available on the glove. Although wireless communication between the handwear and the cycle is preferred, wired connections may also be provided.

Thus, the gloves may include a glove-mounted controller of the one or more illuminators configured to establish a communication link with a remote controller not mounted on the glove and to control at least one aspect of the one or more illuminators based upon a signal received from the remote controller. The glove-mounted controller may be configured to control an aspect of the one or more lighted components selected from the group consisting of: on/off, intensity, blinking pattern, color, and combination thereof, based upon a signal received from the remote controller. The glove-mounted controller may be configured to change the aspect of the one or more lighted components based upon a signal from the remote controller corresponding to activation of one or more lights on the motorcycle consisting of: a turn signal, a hazard flasher, a brake light, a headlight, a parking light, a running light, or a combination thereof.

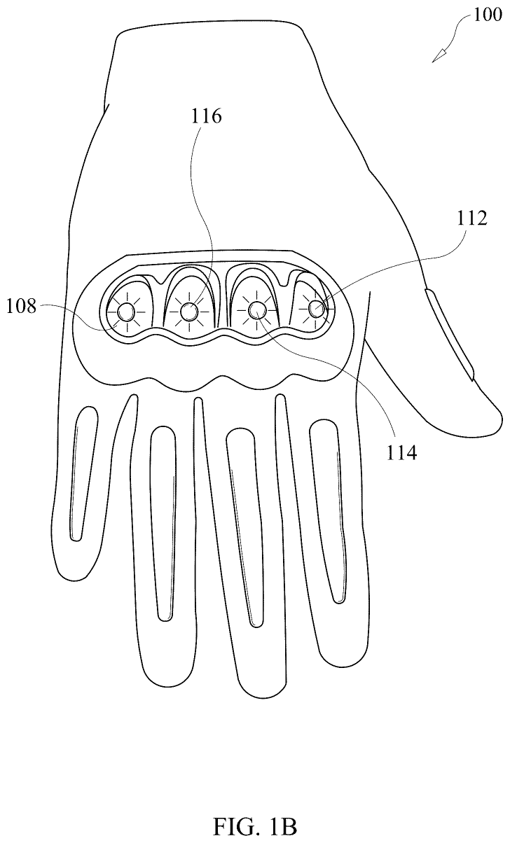

In other embodiments, the gloves may be completely independent of the bike and of any external controllers. In embodiments, such as is depicted in FIG. 2, one or more activation switches 202, 204, 206 are integrated into the glove for providing a user interface controlling one or more functions, such as but not limited to on/off status, color selection, and illumination pattern. For example, the activation switches may comprise one or more push buttons operable by pushing them in a direction from an exterior of the glove toward the hand of the wearer. While not limited to any particular location, buttons aligned with a dorsal aspect of the wear's hand proximal the wearer's index finger and thumb are relatively easy for a cyclist to utilize by lifting one hand off of the handlebars and pushing the button of the opposite gloved hand that can retain a grip on the other handlebar. A single button (e.g. 202) embodiment may be configured to scroll through positions of OFF—FIRST COLOR ON—SECOND COLOR ON—FIRST COLOR BLINKING—SECOND COLOR BLINKING—OFF. Glove embodiments with set of multiple buttons (e.g. 202, 204, 206) may be configured with one controlling on/off, another controlling color (e.g. WHITE—COLOR PATTERN 1—COLOR PATTERN 2—ETC.), and yet another controlling blink status (e.g. STATIC—BLINKING PATTERN 1—BLINKING PATTERN 2—STROBING PATTERN 1—STROBING PATTERN 2—ETC.). Two button (e.g. 202, 204) embodiments may have blinking and color on one button, or on/off/color on one button, and blink/flash/strobe pattern on the other. Four button options (not shown) may have one button for each of: on/off, color, blink/no blink, blink pattern. The invention is not limited to any particular number of buttons or functions thereof, nor to any particular structure (button, dial, slide, etc.).

Thus, schematically, each glove may comprise a power supply 402, one or more embedded switches 404, a glove-mounted controller 408, and the plurality of lights 406. The power supply may include a battery, such as a rechargeable battery, and in embodiments the glove may include a recharging port, such as an USB C port on the exterior of the glove, connected to the power supply and configured to recharge the battery in situ (without having to remove the battery). Other embodiments may be configured to use disposable, or removable, rechargeable batteries. In embodiments, as described herein, the glove-mounted controller 408 may be in communication with a remote controller 410 such as may be associated with a mobile device programmed with application software, or a bike-mounted controller. In embodiments without remote control, glove controller 408 may control blinking/flashing patterns, color, and the like based only upon selections made via the one or more embedded switches.

In embodiments, the gloves come in pairs: one glove configured to be worn on each of a left hand and one to be worn on a right hand, wherein each of the pair of gloves comprises a glove as described herein. Glove pairs may be sold with accessories (not shown), such as one or more chargers (e.g. for connecting to a wall plug, USB, cigarette lighter, etc. on the end opposite to the end that physically connects to the glove). In embodiments, the gloves may be configured with components configured to permit wireless charging when placed on a stand or pad (not shown), such as wireless charging stations and corresponding components used in mobile phones, smart watches, wireless earphones/headphones, and the like. Such accessories are generally well known in the art for use in connection with other types of electronics, and not detailed herein further.

Embodiments of the invention include glove systems including the pair of gloves as described herein, and a glove-mounted controller disposed in each of the gloves. In embodiments in which each glove-mounted controller is configured to be communicatively coupled to a remote controller configured to control an aspect of the one or more lighted components in the glove based upon a signal received from the remote controller, the remote controller may be a cycle-mounted controller configured to communicate an illumination signal from the cycle or a mobile-device-mounted controller comprising interactive application software running on the mobile device configured to send one or more operating signals to the glove based upon wearer input. Accordingly, some glove system embodiments may include a component configured to mate with or otherwise connect to a corresponding component on the cycle and communicate with the glove. Other glove system embodiments may include a downloadable mobile device application (app) (e.g. from the Apple App Store or Google Play store, or another source) configurable to communicate with a specific pair of gloves via the mobile device (e.g. via Bluetooth).

In preferred embodiments, the gloves meet safety standards for motorcycle gloves. For example, the CE EN 13594:2015 standard “Protective gloves for motorcyclists” defines tests to certify protective gloves for motorcyclists. Gloves meeting this standard are designed to protect motorcyclists from the external elements without excessively hindering the dexterity of the rider in operating the motorcycle controls. The gloves are designed to ensure the mechanical protection of the hands and wrists in case of an accident. Gloves meeting the Level 1 performance standard are designed with a minimum level of protection to ensure effective protection in case of an accident and to provide an optimum level of comfort for all types of driving, whereas those meeting the level 2 standard are designed to ensure elevated performance levels of protection in relation to the type of driving. Some gloves may have conductive metal fibers on the index finger and thumb on both gloves, in order to work with touch screen devices. Gloves meeting the CE standards may have abrasion resistance for greater than equal to 4 s (Level 1) or 8 s (Level 2), knuckle protection impact transmission resistance (maximum transmitted force from an impact created by dropping a 2.5-kilogram mass onto each glove with an impact energy of 5 joules) optionally less than 9 kN (Level 1) or mandatory less than 5 kN (Level 2), tearing resistance greater than or equal to 25 N on the palm and 18 N on the back of the hand (Level 1) or greater than or equal to 35 N on the palm and 30 N on the back of the hand, main seam resistance to traction of less than 6 N/mm (Level 1) or less than 10 N/mm (Level 2), support resistance of greater than or equal to 25 N (Level 1) or 50 N (Level 2), and cutting resistance on the palm of greater than 1.2 N Level 1) or greater than or equal to 1.8 on the palm and greater than or equal to 1.2 N on the back of the hand (Level 2).

While the embodiments as described herein depict strong protection for the cycle rider, it should be understood that handwear embodiments comprising lesser protection overall for the hands of the wearer may still be provided with the illumination features. The invention is not limited to any particular type of handwear or degree of protectivity, except as expressly recited in the appended claims.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. Handwear configured to be worn on a donned hand of a wearer, the handwear comprising one or more lighted components configured to emit light visible from at least a position distal and laterally adjacent to the donned hand of the wearer.

2. The handwear of claim 1, comprising a plurality of lighted components, each lighted component positioned to align with the dorsal aspect of one of the metacarpophalangeal finger joints of the donned hand of the wearer.

3. The handwear of claim 2, comprising four lighted components, each positioned to align with the dorsal aspect of one of the metacarpophalangeal finger joints of the donned hand of the wearer.

4. The handwear of claim 3, wherein the handwear comprises a glove, and each of the lighted components is inset within a rigid knuckle-protective member positioned to align with the dorsal aspect of one of the metacarpophalangeal finger joints of the donned hand of the wearer.

5. The handwear of claim 2, wherein at least one of the lighted components is configured to have a different color than at least one of the other of the plurality of lighted components or wherein the one or more lighted components are configured to blink, flash, or strobe in one or more patterns.

6. The handwear of claim 5, wherein the one or more lighted components are configured to blink, flash, and/or strobe between a first color light and a second color light or to strobe a static color.

7. The handwear of claim 6, wherein each of the plurality of lighted components is configured to alternate between a first color light and a second color light, wherein the first color light of each lighted component is different from the first color light of each other lighted component, and the second color light of all of the lighted components is the same.

8. The handwear of claim 6, wherein the second color light comprises white light, and the first color light is selected from the group consisting of: yellow, green, orange, and non-emergency shades of red and blue.

9. The handwear of claim 1, further comprising a handwear-mounted controller of the one or more lighted components configured to establish a communication link with a second controller not mounted on the handwear and to control at least one aspect of the one or more lighted components based upon a signal received from the second controller.

10. The handwear of claim 9, wherein the second controller comprises application software installed on a mobile device.

11. The handwear of claim 9, wherein the second controller is configured to control lighted features of a vehicle operated by the wearer.

12. The handwear of claim 11, wherein the first controller is configured to control an aspect of the one or more lighted components selected from the group consisting of: on/off, intensity, blinking/flashing/strobing pattern, color, and combination thereof, based upon a signal received from the second controller.

13. The handwear of claim 12, wherein the first controller is configured to change the aspect of the one or more lighted components based upon a signal from the second controller corresponding to activation of one or more lights on the motorcycle consisting of: a turn signal, a hazard flasher, a brake light, a headlight, a parking light, a running light, or a combination thereof.

14. The handwear of claim 1, further comprising at least one activation switch disposed on the handwear for controlling one or more functions of the one or more lighted components selected from the group consisting of: on/off status, color selection, and illumination pattern.

15. The glove of claim 4, wherein the glove has a knuckle protection impact transmission resistance of less than 9 kN, optionally less than 5 kN, to an impact created by dropping a 2.5-kilogram mass onto the glove with an impact energy of 5 joules.

16. The handwear of claim 1 comprising one item of handwear configured to be donned on a left hand and another item of handwear configured to be donned a right hand of the wearer, the one and the another items of handwear comprising a pair.

17. A handwear system comprising the pair of handwear of claim 16, a handwear-mounted controller disposed in each item of handwear, each handwear-mounted controller configured to be communicatively coupled to a remote controller configured to control an aspect of the one or more lighted components in at least one of the items of handwear based upon a signal received from the remote controller.

18. The handwear system of claim 17, further comprising the remote controller, wherein the remote controller is a vehicle-mounted controller configured to communicate an illumination signal from the vehicle or a mobile-device-mounted controller comprising interactive application software running on the mobile device configured to send one or more operating signals to the handwear based upon wearer input.

19. A glove or pair of gloves configured to be worn on at least one donned hand of a wearer, each glove comprising each glove comprising a plurality of lighted components, each lighted component configured to emit light visible from at least a position distal and laterally adjacent to the donned hand of the wearer, each of the lighted components inset within a rigid knuckle-protective member positioned to align with the dorsal aspect of one of the metacarpophalangeal finger joints of the donned hand of the wearer, each glove having a knuckle protection impact transmission resistance of less than 9 kN, measured by dropping a 2.5-kilogram mass onto the glove with an impact energy of 5 joules.

20. The glove or pair of gloves of claim 19, wherein:
at least one lighted component is configured to have a different color than at least one other lighted component;
the one or more lighted components are configured to blink, flash, or strobe in one or more illumination patterns; or
a combination thereof.

21. The glove or pair of gloves of claim 20, wherein each glove comprises a glove-mounted controller configured to: control the plurality of lighted components, establish a communication link with a second controller not mounted on the glove, control at least one aspect of the one or more lighted components based upon a signal received from the second controller, or combination thereof.

22. A glove or pair of gloves of claim 20, further comprising at least one activation switch disposed on at least one glove for controlling one or more functions selected from the group consisting of: on/off status, color selection, and illumination pattern.
